(19) United States
(12) Patent Application Publication
(10) Pub. No.: US 2026/0145061 A1
(43) Pub. Date: May 28, 2026

(54) HANDHELD FORCE FEEDBACK SYSTEM

(71) Applicant: National Taiwan University, Taipei (TW)

(72) Inventors: Shiang-Fong CHEN, Taipei (TW); Yu-Ming CHIEN, Taipei (TW)

(21) Appl. No.: 19/178,557

(22) Filed: Apr. 14, 2025

(30) Foreign Application Priority Data
Apr. 15, 2024 (TW) 113113968

(51) Int. Cl. A63F 13/285; A63F 13/245; A63F 13/577; G06F 3/01

(52) U.S. Cl. CPC A63F 13/285; A63F 13/245; A63F 13/577; G06F 3/011; G06F 3/016; A63F 2300/8082

(57) ABSTRACT

The present invention relates to a handheld force feedback system. The system comprises a direction feedback unit, a displacement feedback unit, a vibration feedback unit, and a control unit. The control unit is used to convert a collision force into an output displacement and to control the direction feedback unit to generate a reverse force on the basis of the output displacement. The control unit further converts the output displacement into an output signal for controlling the displacement feedback unit and the vibration feedback unit to generate a co-directional force and a vibration force respectively.

### CROSS REFERENCE

This non-provisional application claims priority of Taiwan Invention Patent Application No. 113113968, filed on Apr. 15, 2024, the contents thereof are incorporated by reference herein.

### TECHNICAL FIELD

The present invention relates to a handheld force feedback system, particularly a device which can generate force feedback perceptions corresponding to actions, such as striking, hitting, cutting, chopping and the like in a virtual environment, in the hand and its system.

### BACKGROUND OF THE INVENTION

In recent years, with the development of virtual reality (VR) technology, the audio-visual presentation technology of virtual environments has also grown rapidly. However, the simulation effect is approaching saturation because when touching and manipulating objects in the virtual environment, the lack of tactile senses will seriously affect the user's immersion experience. As a result, the function of tactile perception has gradually received more attentions, and many researchers have also begun to develop the field of tactile reproduction.

There are many commercial VR displays and VR controllers, such as Oculus Rift, HTC VIVE, Sony Playstation VR, etc., on the market. In addition to visually interacting with the environment, the controllers also provide users with tactile information.

Existing VR controllers currently use built-in vibration motors or piezoelectric actuators to give users binary (on or off) vibration feedback. Although this feedback can deepen the reality of the environment and increase interactive fun, it is still not enough to realize application environments with higher requirements for tactile simulation. Therefore, how to achieve high-fidelity tactile feedback will be a major problem that VR technology needs to solve.

In response to the above problem, the present invention uses three different feedback mechanisms integrated in a handheld force feedback device. Therefore, when a collision is detected in the virtual environment, the collision force can be converted into an output displacement. On the basis of the output displacement, the handheld force feedback device can generate a reverse force, a co-directional force, and a vibration force. This allows the user's hand to receive complex tactile senses in real time so that in combination with virtual audio-visual presentation technology, the user can receives three sensory feedbacks including visual, auditory, and tactile senses at the same time in the virtual environment. Therefore, the present invention should be an optimal solution.

### SUMMARY OF THE INVENTION

A handheld force feedback system comprises a handheld force feedback device. The handheld force feedback device includes a direction feedback unit, disposed at a position between the thumb and the index finger of a human body and at least having a first actuator, the first actuator being capable of generating a reverse force opposite to an applied force in direction; a displacement feedback unit, disposed at a position corresponding to finger pulps of the human body and having a second actuator and a push rod mechanism, the second actuator provided with a turning linkage extending, the turning linkage holding up the push rod mechanism, the second actuator operating to rotate the turning linkage and then to push and displace the push rod mechanism downward for generating a co-directional force in the same direction as the applied force; and a control unit, electrically connected to the direction feedback unit and the displacement feedback unit, the control unit used to convert a collision force into an output displacement and then to convert the output displacement into a rotation angle of the second actuator, and the control unit further generating a first input voltage for driving the first actuator on the basis of the output displacement.

More particularly, the push rod mechanism of the displacement feedback unit is disposed at a position corresponding to the inner sides of the middle finger, the ring finger, and the little finger of the human body, and the second actuator operates to rotate the turning linkage and then to push and displace the push rod mechanism downward against the inner sides of the middle finger, the ring finger, and the little finger of the human body for generating the co-directional force.

More particularly, the push rod mechanism of the displacement feedback unit is further connected with a spring element; when the second actuator operates to rotate the turning linkage, the push rod mechanism is pushed and displaced downward from an original position, and the spring element is stretched; when the second actuator operates again to return the turning linkage, the spring element is rebounded, and the push rod mechanism is displaced upward so that the push rod mechanism returns to the original position.

More particularly, the direction feedback unit and the displacement feedback unit are integrated in a handle bar body.

More particularly, the handheld force feedback system further comprises a tracking device, electrically connected to the handheld force feedback device, the tracking device sending out spatial motion information that tracks the handheld force feedback device when the handheld force feedback device moves; and an electronic apparatus, electrically connected to a display (a head-mounted display or a regular screen) and the tracking device and having a built-in virtual reality application program, the electronic apparatus receiving the spatial motion information, the virtual reality application program used to generates interactive information on the basis of the spatial motion information, the electronic apparatus sending the interactive information to the control unit, the control unit converting the interactive information into the collision force, converting the collision force into the output displacement, and then converting the output displacement into the rotation angle of the second actuator, and the control unit further generating the first input voltage for driving the first actuator on the basis of the output displacement.

More particularly, the tracking device transmits the spatial motion information to the electronic apparatus, the electronic apparatus displays a virtual collision action of a virtual object synchronously in a virtual environment through the display, and after the electronic apparatus detects the virtual collision action, it transmits the interaction information to the control unit.

A handheld force feedback system comprises a handheld force feedback device. The handheld force feedback device includes a direction feedback unit, disposed at a position between the thumb and the index finger of a human body and at least having a first actuator, the first actuator being capable of generating a reverse force opposite to an applied force in direction; a displacement feedback unit, disposed at a position corresponding to finger pulps of the human body and having a second actuator and a push rod mechanism, the second actuator provided with a turning linkage extending, the turning linkage holding up the push rod mechanism, the second actuator operating to rotate the turning linkage and then to push and displace the push rod mechanism downward for generating a co-directional force in the same direction as the applied force; a vibration feedback unit, disposed at a position corresponding to finger pulps of the human body and having a third actuator, the third actuator being capable of vibrating to generate a vibration force; and a control unit, electrically connected to the direction feedback unit, the displacement feedback unit, and the vibration feedback unit, the control unit used to convert a collision force into an output displacement and then to convert the output displacement into a rotation angle of the second actuator, and the control unit further generating a third input voltage for driving the third actuator and a first input voltage for driving the first actuator on the basis of the output displacement.

More particularly, the push rod mechanism of the displacement feedback unit is disposed at a position corresponding to the inner sides of the middle finger, the ring finger, and the little finger of the human body, and the second actuator operates to rotate the turning linkage and then to push and displace the push rod mechanism downward against the inner sides of the middle finger, the ring finger, and the little finger of the human body for generating the co-directional force.

More particularly, the push rod mechanism of the displacement feedback unit is further connected with a spring element; when the second actuator operates to rotate the turning linkage, the push rod mechanism is pushed and displaced downward from an original position, and the spring element is stretched; when the second actuator operates again to return the turning linkage, the spring element is rebounded, and the push rod mechanism is displaced upward so that the push rod mechanism returns to the original position.

More particularly, the third actuator of the vibration feedback unit is adjusted by regulating the third input voltage for generating different vibration amplitudes.

More particularly, the direction feedback unit, the displacement feedback unit, and the vibration feedback unit are integrated in a handle bar body.

More particularly, the handheld force feedback system further comprises a tracking device, electrically connected to the handheld force feedback device, the tracking device sending out spatial motion information that tracks the handheld force feedback device when the handheld force feedback device moves; and an electronic apparatus, electrically connected to a display and the tracking device and having a built-in virtual reality application program, the electronic apparatus receiving the spatial motion information, the virtual reality application program used to generates interactive information on the basis of the spatial motion information, the electronic apparatus sending the interactive information to the control unit, the control unit converting the interactive information into the collision force, converting the collision force into the output displacement, and then converting the output displacement into the rotation angle of the second actuator, and the control unit further generating the third input voltage for driving the third actuator and the first input voltage for driving the first actuator on the basis of the output displacement.

More particularly, the tracking device transmits the spatial motion information to the electronic apparatus, the electronic apparatus displays a virtual collision action of a virtual object synchronously in a virtual environment through the display, and after the electronic apparatus detects the virtual collision action, it transmits the interaction information to the control unit.

### BRIEF DESCRIPTION OF DRAWINGS

FIG. 1A is a schematic diagram showing a system architecture of a handheld force feedback system according to the present invention.

FIG. 1B is a schematic diagram showing an architecture of an electronic apparatus of the handheld force feedback system according the present invention.

FIG. 2 is a schematic diagram showing a first implementation architecture of a handheld force feedback device of the handheld force feedback system according the present invention.

FIG. 3 is a schematic diagram showing a second implementation architecture of the handheld force feedback device of the handheld force feedback system according the present invention.

FIG. 4A is a schematic exploded diagram showing the structure of the handheld force feedback device of the handheld force feedback system according the present invention.

FIG. 4B is an schematic assembly diagram showing the structure of the handheld force feedback device of the handheld force feedback system according the present invention.

FIG. 4C is a schematic diagram showing the connection of a control unit of the handheld force feedback system according to the present invention.

FIG. 5 is a schematic diagram of holding the handheld force feedback device of the handheld force feedback system according the present invention.

FIG. 6 is a schematic diagram showing the operation of a second actuator of the handheld force feedback system according to the present invention.

FIG. 7 is a schematic diagram showing the relationship between an output displacement and a motor rotation angle of the handheld force feedback system according to the present invention.

### DETAILED DESCRIPTION OF THE INVENTION

Other technical contents, features, and effects of the present invention will become apparent from the following detailed description of preferred embodiments with reference to the drawings.

The electrical connection described below in the present invention refers to wired or wireless connection, which is used to generate unidirectional and/or bidirectional digital signal and/or analog signal transmissions between electronic components.

The circuit controller described below in the present invention is a micro controller unit (MCU). The MCU at least includes a CPU, a memory (such as ROM and RAM), and a related peripheral device (such as ADC, DAC, GPIO, PWM). Data, such as programmed actions, instructions, and variables, are written into the memory, and then the CPU can execute these programmed actions in sequence.

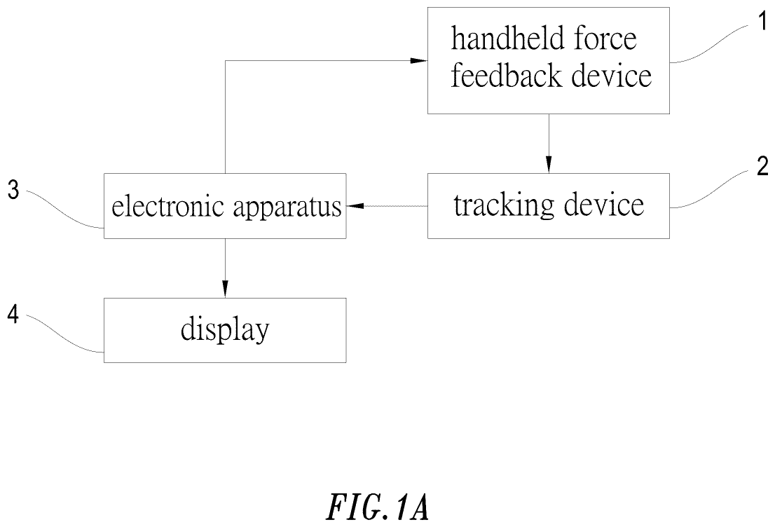

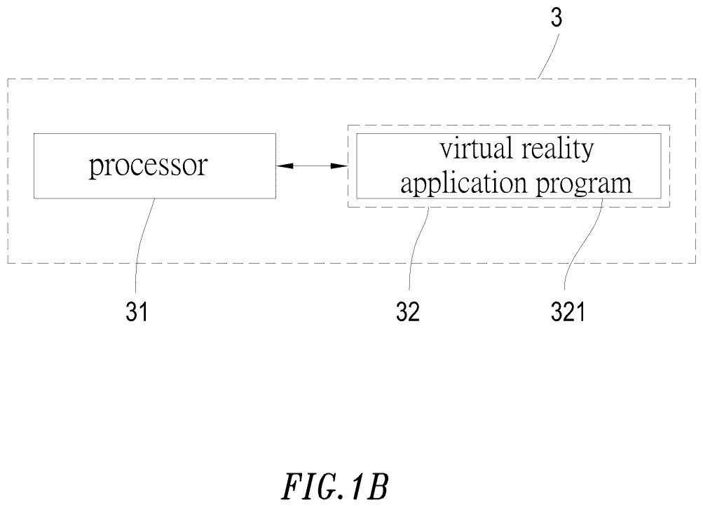

As shown in FIG. 1A, a handheld force feedback system includes a handheld force feedback device 1, a tracking device 2, an electronic apparatus 3, and a display 4. The electronic apparatus 3 is any one of a desktop computer, a notebook computer, a server, a display (such as Occulus, Vision Pro or a computer screen), which can compute and execute virtual reality-related applications.

The electronic apparatus 3 is electrically connected to the tracking device 2 and the display 4. As shown in FIG. 1B, the electronic apparatus 3 includes at least one processor 31 and at least one computer-readable recording medium 32, wherein the computer-readable recording medium 32 has a virtual reality application program 321 inside; the computer-readable recording medium 32 further stores computer-readable instructions. When the computer-readable instructions are executed by the processor 31, the virtual reality application program 321 can be run. In the present invention, the electronic apparatus 3, the tracking device 2, and the display 4 are three separate components for illustration. However, in actual situations, the display 4 can also be designed to have the functions of the electronic apparatus 3 and the tracking device 2.

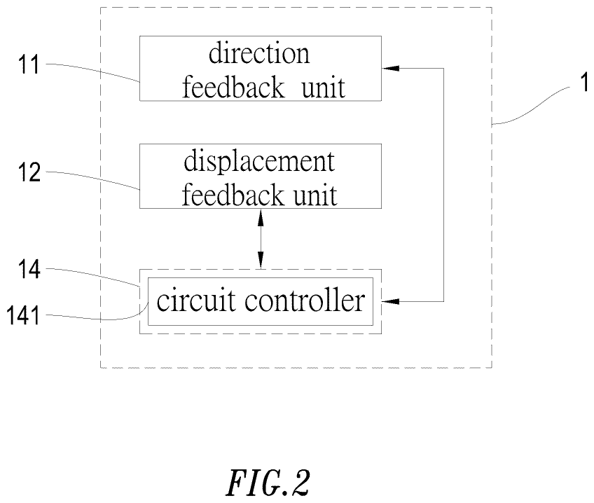

FIG. 2 is a schematic diagram showing a first implementation architecture of the handheld force feedback device 1. As shown in FIG. 2, the handheld force feedback device 1 has a direction feedback unit 11, a displacement feedback unit 12, and a control unit 14.

The direction feedback unit 11 is disposed at a position between the thumb and the index finger of a human body. The direction feedback unit 11 at least has a first actuator. The first actuator generates a reverse force opposite to an applied force in direction between the thumb and index finger of the human body. Any electronic component that can achieve this purpose will fall within the scope of protection, such as a voice coil actuator, etc.

Taking the voice coil actuator as an example of the first actuator, the first actuator generates asymmetric vibrations on the facing side of the hand (a holding position between the thumb and index finger) by inputting a specific form of current signal, thereby simulating sense of the direction of the reverse force felt on the hand when hitting with an object held. In the present invention, the voice coil actuator is used as an example, but practical applications are not limited to the voice coil actuator.

As to the driving method of the first actuator in the present invention, the DAC pin of the control unit 14 (for example, the Teensy development board) is used to output a first input voltage, at the same time, a voltage-dividing circuit and a buffer amplifier are used to generate a bias signal, and a subtraction operation on the two signals are performed by a differential amplifier, thereby generating an input current signal. An output acceleration amplitude will generate a reverse force opposite to an applied force in direction only when the maximum input current exceeds a certain value.

The displacement feedback unit 12 is disposed at a position corresponding to the pulps of the middle finger, the ring finger, and little finger of the human body. The displacement feedback unit 12 has a second actuator and a push rod mechanism. The second actuator is provided with a turning linkage extending, and the turning linkage holds up the push rod mechanism. The second actuator operates to rotate the turning linkage and then to push and displace the push rod mechanism downward for generating a co-directional force in the same direction as an applied force on the pulps of the middle finger, the ring finger, and little finger of the human body. Any electronic component that can achieve this purpose will fall within the scope of protection, such as a servo motor, etc.

Taking the servo motor as an example of the second actuator, the the driving method of the second actuator in the present invention is based on the output displacement of the push rod mechanism. According to mechanism limitations, it is possible to know the maximum displacement and the maximum motor input voltage to achieve the maximum displacement. Since there is a linear relationship between the output displacement and the driving voltage, after an output displacement is generated by the control unit 14 through conversion, a second driving voltage can be generated through conversion on the basis of the maximum displacement and the maximum motor input voltage to control the operation of the second actuator so that the turning linkage can drive and displace the push rod mechanism downward to generate a co-directional force that conforms to the output displacement. In the present invention, the servo motor is used as an example, but practical applications are not limited to the servo motor.

The control unit 14 is electrically connected to the direction feedback unit 11 and the displacement feedback unit 12. The control unit 14 at least has a circuit controller 141. The circuit controller 141 is used to convert a collision force into an output displacement and then to convert the output displacement into the rotation angle of the second actuator, and the circuit controller 141 further generates a first input voltage for driving the first actuator on the basis of the output displacement.

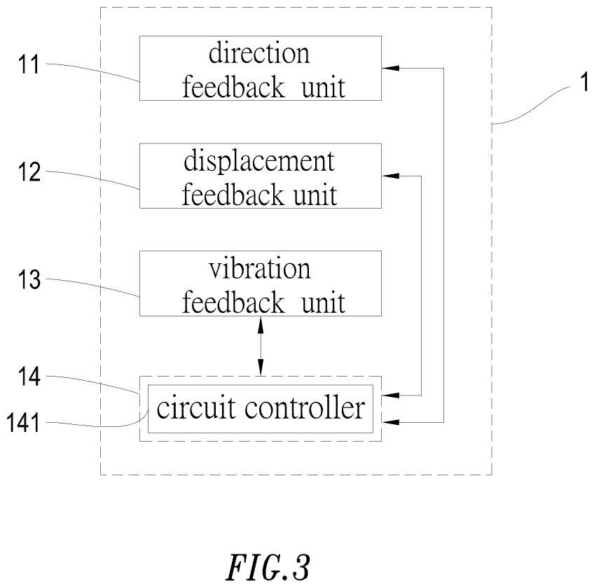

The handheld force feedback device 1 in the present invention has a second embodiment. As shown in FIG. 3, the handheld force feedback device 1 includes a direction feedback unit 11, a displacement feedback unit 12, a vibration feedback unit 13, and a control unit 14, and the contents of the direction feedback unit 11 and the displacement feedback unit 12 are the same as those previously mentioned above so they will not be repeated.

The vibration feedback unit 13 is disposed at a position corresponding to finger pulps or the palm of the human body. The vibration feedback unit 13 has a third actuator, which can vibrate to generate a vibration force. The rotation speed of the third actuator can be adjusted by regulating a third input voltage to produce different vibration amplitudes. Any electronic component that can achieve this purpose will fall within the scope of protection, such as a vibration motor, etc.

Taking the vibration motor as an example of the third actuator, the driving method of the third actuator is to use the PWM pin of the control unit 14 to output a driving voltage, and then to input it to the motor end through a buffer amplifier. Therefore, after an output displacement is generated by the control unit 14 through conversion, as previously described, a third input voltage can be generated on the basis of the output displacement to control the operation of the third actuator. In the present invention, the vibration motor is used as an example, but practical applications are not limited to the vibration motor.

The control unit 14 is electrically connected to the direction feedback unit 11, the displacement feedback unit 12, and the vibration feedback unit 13. The control unit 14 at least has a circuit controller 141. The circuit controller 141 is used to convert a collision force into an output displacement, and then to convert the output displacement into the rotation angle of the second actuator, and the circuit controller 141 further generates a third input voltage for driving the third actuator and a first input voltage for driving the first actuator on the basis of the output displacement.

Next, the structure of the handheld force feedback device 1 will be further described. In the present invention, the direction feedback unit 11, the displacement feedback unit 12, the vibration feedback unit 13, and the control unit 14 of the second embodiment are integrated into a handle bar to present one structural aspect. However, this aspect is only one of structural aspects. During actual implementation, this aspect can be changed as needed.

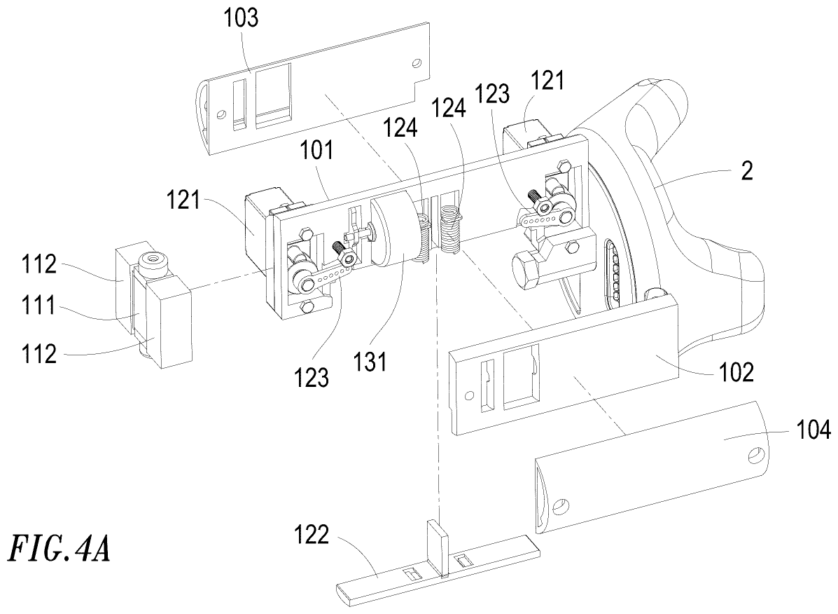

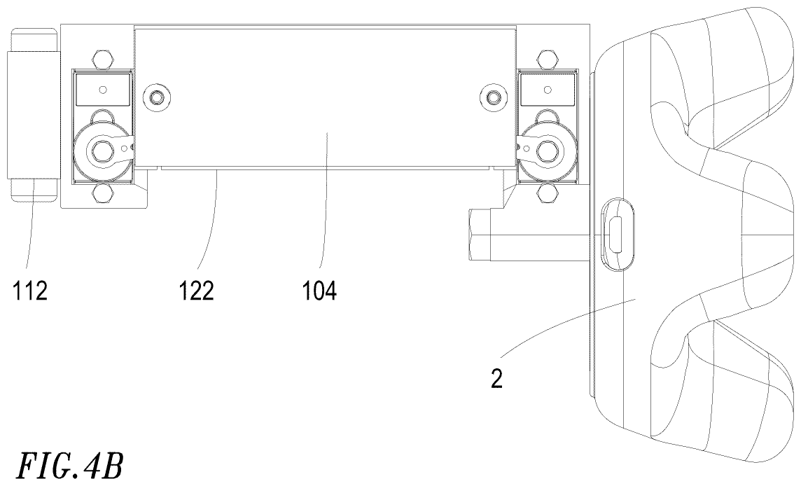

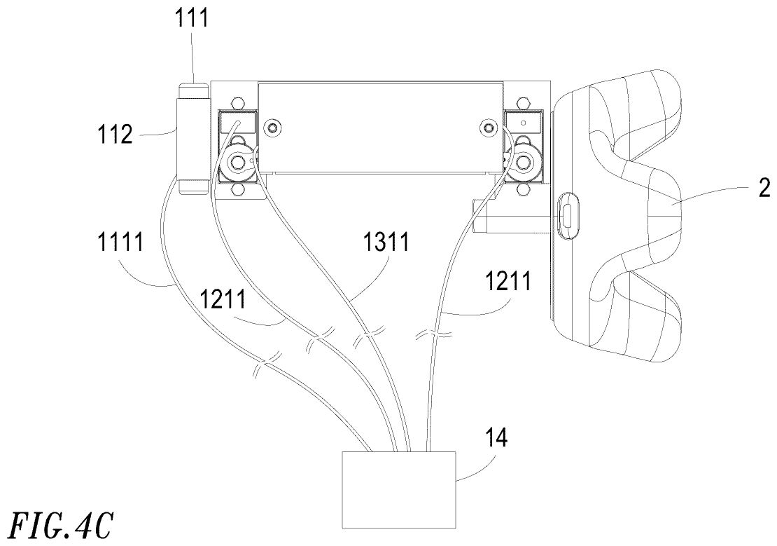

As shown in FIGS. 4A and 4B, the direction feedback unit 11, the displacement feedback unit 12, and the vibration feedback unit 13 are integrated into a handle bar body 10. The handle bar body 10 of the handheld force feedback device 1 can be connected to a tracking device 2. In this implementation, it is designed with a base 101. Two second actuators 121 and a third actuator 131 are accommodated on the base 101. The base 101 and its components are covered with shells 102, 103, 104. In addition, the front end of the base 101 is combined with a first actuator 111

A push rod mechanism 122 is provided between the two second actuators 121, and each second actuator 121 has a turning linkage 123 extending. The turning linkage 123 holds up the push rod mechanism 122. Moreover, the push rod mechanism 122 is further connected with a spring element 124.

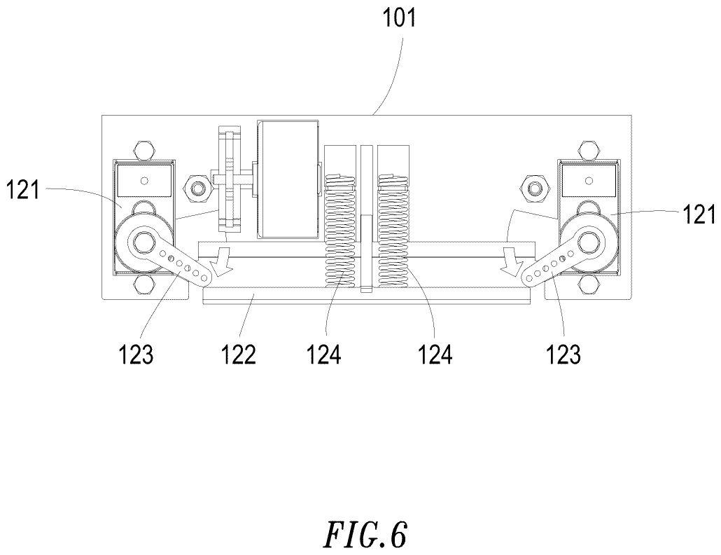

When the second actuators 121 operate, as shown in FIG. 6, the two second actuators 121 (such as, servo motors) output torque at the same time while their turning linkages 123 will rotate (the left turning linkage is in clockwise movement; the right turning linkage is in counterclockwise movement) at the same time to push the push rod mechanism 122 below so that the push rod mechanism 122 is moved vertically downward to apply force on the last three fingers holding the handle bar, and at the same time, the spring element 124 will be stretched.

When the second actuator 121 (such as a servo motor) rotates to a command angle, it will immediately return to an initial angle. At this time, the push rod mechanism 122 will be affected by the force of the spring element 124 and driven and displaced upward so that the push rod mechanism 122 returns to an original position.

As shown in FIG. 4C, the first actuator 111, the second actuators 121, and the third actuator 131 are respectively provided with connecting lines 1111, 1211, 1311 extending outward for connecting to the control unit 14. In this embodiment, the control unit 14 is designed in a box shape and has a circuit substrate inside. There is a circuit controller 141 on the circuit substrate, and one or more connection ports are provided on the surface of the control unit 14 for electrically connecting with the connecting lines 1111, 1211, 1311.

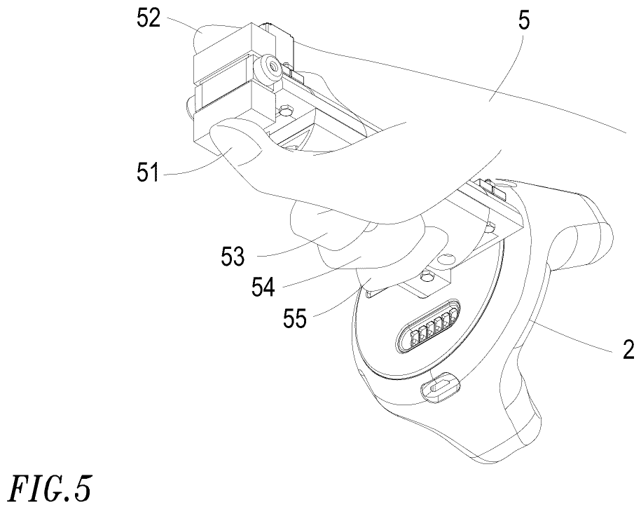

As shown in FIG. 5, it is an aspect in which the user holds the handle bard body 10, wherein the first actuator 111 is located between the thumb 51 and the index finger 52 of a human hand 5. The last three fingers (the middle finger 53, the ring finger 54, and the little finger 55) of the human hand 5 will buckle on the outside of the shells 103, 104, and will contact the push rod mechanism 122 at the bottom.

Next, the operation mechanism of the handheld force feedback device 1 will be further illustrated together with the tracking device 2, the electronic apparatus 3, and the display 4. First, the tracking device 2, the electronic apparatus 3, and the display 4 will be illustrated in more detail.

The display 4 can be implemented as HTC VIVE equipment, but the present invention is not limited to HTC VIVE equipment. Any display that can be used for virtual reality simulation is suitable for the technology of the present invention.

The tracking device 2 can be implemented as HTC VIVE Tracker. HTC VIVE Tracker is a mobile locator equipped with the Lighthouse system. The tracking method of this locator is the same as that of the head-mounted display, in which infrared rays emitted from base stations are received by light-sensitive sensors on its surface and its position and posture in space are calculated. Lighthouse uses infrared base stations as a core, and each base station has an infrared array transmitter. The advantage of Lighthouse positioning technology lies in that the computing power it requires is much less than traditional optical systems; optical technology usually requires a lot of image processing, while Lighthouse only needs to process time parameters and directly transmits data to the computer for calculation so that latency will be significantly reduced and the overall application system can be more smoothly executed.

Since the tracking device 2 (such as the HTC VIVE Tracker) has a standard threaded connection base, the tracking device 2 can be disposed on the handle bar body 10. When the handle bar body 10 moves, the tracking device 2 can receive infrared rays emitted by the base stations to track the position of this device in space in real time and send spatial motion information tracking the handheld force feedback device 1 to the electronic apparatus 3.

The present invention is not limited to HTC VIVE Tracker, but any tracking mechanism that can track the movement trajectory and behavior of the handle bar body 10 is suitable for the technology of the present invention.

The virtual reality application program 321 has two execution softwares (Unity and SteamVR) for implementation, but is not limited to these two softwares, wherein Unity is responsible for the creation and operation of application scenes, calculation of tracking data, object interactions, and transmission of visual, auditory, and tactile information; SteamVR serves as a communication medium for Unity and HTC VIVE, collects tracking data captured by the base stations and Tracker to the electronic apparatus 3, imports them to Unity for data update, and sends the recalculated data back to the handheld force feedback device 1 (such as a driving voltage) and the head-mounted display (such as a visual screen).

Continuing from the previous description (paragraph [51]), when the handle bar body 10 moves, the tracking device 2 can transmit the spatial motion information to the electronic apparatus 3, and the electronic apparatus 3 displays an collision action of a virtual object synchronously in a virtual environment through the display 4. At the same time, the electronic apparatus 3 can further transmit the interactive information to the control unit 14 (the interactive information is one of more of position data, velocity data, acceleration data, angular position data, and angular velocity data). The circuit controller 141 of the control unit 14 converts the interactive information into a collision force, and then converts the collision force into an output displacement. Furthermore, the circuit controller 141 will perform the following operations:
(1)according to the output displacement, a first input voltage for driving the first actuator 111 is generated to control the displacement-dependent pulling force of the first actuator 111;
(2)the output displacement is converted into the rotation angle of the second actuator 121; and
(3)according to the output displacement, a third input voltage for driving the third actuator 131 is generated to control the vibration amplitude of the third actuator 131.

In the present invention, a hitting game, such as a badminton game and a baseball game, is used an embodiment for description, wherein the control unit 14 is implemented as the Teensy development board, which is used as a control end for force sense feedback commands and will receive the interactive information calculated by the virtual reality application program 321 (Unity) to determine whether there is a contact, the force that the device should feedback, etc. and to provide corresponding feedback signals to the three actuators respectively. The force sense signals output by the actuators will be received by the human body to produce corresponding perceptions.

The collision detection implementation design of the virtual environment of the present invention is that when a real hand holds the handle bar body 10 for exercise, a virtual held object will move in synchronization with the real hand; if the virtual held object and a hit object collide, this collision will trigger visual, auditory and tactile feedback.

In order to simulate the force sense feedback of the real world in the virtual environment, the present invention needs to capture information available in the virtual environment and convert this information into the outputs of the actuators. For this purpose, the present invention has established a reproduction method. When the user performs a hitting action in the virtual environment, and it is determined that the virtual held object and the hit object are in collision, spatial information and kinematic information can be converted into a force that should be experienced at the moment of impact through a kinematic relation, and by performing regression on the obtained data, the conversion relationship of Steven's power law type is obtained and listed below:

$$Ψ ( I ) = k {I}^{a} \qquad formula ( 1 )$$

In formula (1), I represents the magnitude of an external physical stimulus (the displacement of the push rod mechanism); Ψ(I) represents the intensity of a brain perception (force magnitude) after the human body is stimulated; a is an exponential relationship between a specific stimulus category and a perception category combination; k is a proportional constant under a specific physical unit; a and k are parameters obtained after using data regression. With this conversion relationship, the strength of force that should be output in the virtual environment can be converted into the output displacement of the push rod mechanism for giving the user the force sense feedback that the user should receive during hitting.

In the virtual environment, it is necessary to convert the kinematic information (velocity υ, angular velocity ω) of the virtual hitting into the force magnitude (feedback amount Fₚₐₗₘ) that the palm of the human hand should receive on the facing side through the kinematic relation and to convert the force magnitude into the output displacement of the push rod mechanism through the regression curve of Steven's power law so that the force sense feedback that the human hand should receive during hitting can be simulated.

To summarizing the previous descriptions (paragraph [61] to paragraph [63]), after the tracking device 2 (such as HTC VIVE Tracker) reads the motion information of the virtual hitting, the force magnitude (feedback amount Fₚₐₗₘ, feedback amount Fₚₐₗₘ is equal to Ψ(I)) that the hand should receive during hitting is calculated and obtained through the kinematics relation, and then, the output displacement of the push rod mechanism is obtained through conversion using formula (1).

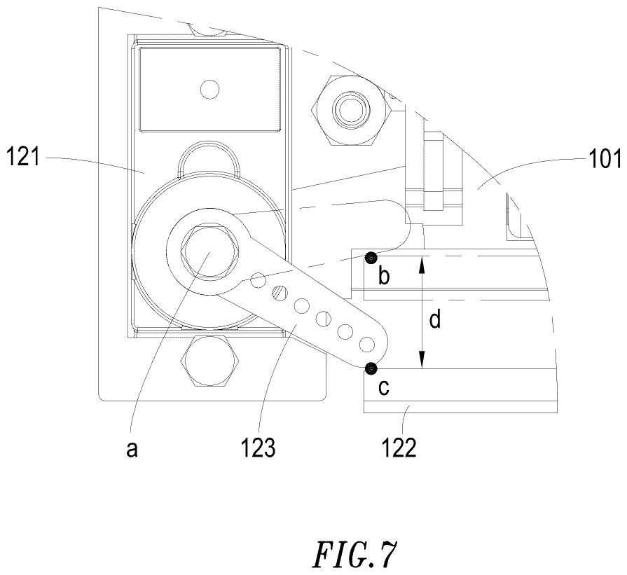

After the output displacement is obtained, the output displacement is converted into the motor rotation angle of the second actuator. As shown in FIG. 7, point a is the center of the rotation axis of the second actuator (such as a servo motor); point b is a contact point between the turning linkage 123 and the push rod mechanism 122 when the push rod mechanism 122 is at the origin; point c is a contact point between the turning linkage 123 and the push rod mechanism 122 when the displacement (the output displacement) of the push rod mechanism is d. Formula (2) for converting the displacement calculated by Steven's power law into the motor rotation angle is as follows:

$$θ = \frac{180}{π} \{ tan ( \frac{d + 0.249}{12.2} ) - tan ( \frac{0.249}{12.2} ) \} \qquad formula ( 2 )$$

wherein θ is the motor output rotation angle of the second actuator (such as a servo motor), and d is the output displacement of the push rod mechanism. After obtaining the motor output rotation angle through conversion, the circuit controller 141 can output a corresponding signal for providing the human hand with force sense feedback.

When compared with other conventional technologies, the handheld force feedback system provided by the present invention has the following advantages:
(1)the combination of three different feedback mechanisms are used to simulate more complex and realistic tactile senses than commercial controllers so that the user is allowed to experience three sensory feedbacks including visual, auditory, and tactile senses simultaneously in the virtual environment;
(2)at a holding position between the thumb and the index finger, the first actuator is used to generate the reverse force sensation opposite to the applied force in direction;
(3)at the pulps of the last three fingers, the second actuator is used to generate the co-directional force sensation in the same direction as the applied force;
(4)The third actuator is used to drive the entire device to generate vibration feedback for giving the entire hand a vibration sensation.

The present invention has been disclosed through the above-mentioned embodiments, but this is not intended to limit the present invention. Any person having ordinary skill in the art can make some changes and modifications without departing from the spirit and scope of the present invention after understanding the foregoing technical features and embodiments of the present invention. Therefore, the patent protection scope of the present invention should be subject to the claims attached to this specification.

What is claimed is:

1. A handheld force feedback system, comprising:
a handheld force feedback device, including:
a direction feedback unit, disposed at a position between the thumb and the index finger of a human body and at least having a first actuator, the first actuator being capable of generating a reverse force opposite to an applied force in direction;
a displacement feedback unit, disposed at a position corresponding to finger pulps of the human body and having a second actuator and a push rod mechanism, the second actuator provided with a turning linkage extending, the turning linkage holding up the push rod mechanism, the second actuator operating to rotate the turning linkage and then to push and displace the push rod mechanism downward for generating a co-directional force in the same direction as the applied force; and
a control unit, electrically connected to the direction feedback unit and the displacement feedback unit, the control unit used to convert a collision force into an output displacement and then to convert the output displacement into a rotation angle of the second actuator, and the control unit further generating a first input voltage for driving the first actuator on the basis of the output displacement.

2. The handheld force feedback system of claim 1, wherein the push rod mechanism of the displacement feedback unit is disposed at a position corresponding to the inner sides of the middle finger, the ring finger, and the little finger of the human body, and the second actuator operates to rotate the turning linkage and then to push and displace the push rod mechanism downward against the inner sides of the middle finger, the ring finger, and the little finger of the human body for generating the co-directional force.

3. The handheld force feedback system of claim 1, wherein the push rod mechanism of the displacement feedback unit is further connected with a spring element; when the second actuator operates to rotate the turning linkage, the push rod mechanism is pushed and displaced downward from an original position, and the spring element is stretched; when the second actuator operates again to return the turning linkage, the spring element is rebounded, and the push rod mechanism is displaced upward so that the push rod mechanism returns to the original position.

4. The handheld force feedback system of claim 1, wherein the direction feedback unit and the displacement feedback unit are integrated in a handle bar body.

5. The handheld force feedback system of claim 1, further comprising: a tracking device, electrically connected to the handheld force feedback device, the tracking device sending out spatial motion information that tracks the handheld force feedback device when the handheld force feedback device moves; and an electronic apparatus, electrically connected to a display and the tracking device and having a built-in virtual reality application program, the electronic apparatus receiving the spatial motion information, the virtual reality application program used to generates interactive information on the basis of the spatial motion information, the electronic apparatus sending the interactive information to the control unit, the control unit converting the interactive information into the collision force, converting the collision force into the output displacement, and then converting the output displacement into the rotation angle of the second actuator, and the control unit further generating the first input voltage for driving the first actuator on the basis of the output displacement.

6. The handheld force feedback system of claim 5, wherein the tracking device transmits the spatial motion information to the electronic apparatus, the electronic apparatus displays a virtual collision action of a virtual object synchronously in a virtual environment through the display, and after the electronic apparatus detects the virtual collision action, it transmits the interaction information to the control unit.

7. A handheld force feedback system, comprising:
a handheld force feedback device, including:
a direction feedback unit, disposed at a position between the thumb and the index finger of a human body and at least having a first actuator, the first actuator being capable of generating a reverse force opposite to an applied force in direction;
a displacement feedback unit, disposed at a position corresponding to finger pulps of the human body and having a second actuator and a push rod mechanism, the second actuator provided with a turning linkage extending, the turning linkage holding up the push rod mechanism, the second actuator operating to rotate the turning linkage and then to push and displace the push rod mechanism downward for generating a co-directional force in the same direction as the applied force;
a vibration feedback unit, disposed at a position corresponding to finger pulps of the human body and having a third actuator, the third actuator being capable of vibrating to generate a vibration force; and
a control unit, electrically connected to the direction feedback unit, the displacement feedback unit, and the vibration feedback unit, the control unit used to convert a collision force into an output displacement and then to convert the output displacement into a rotation angle of the second actuator, and the control unit further generating a third input voltage for driving the third actuator and a first input voltage for driving the first actuator on the basis of the output displacement.

8. The handheld force feedback system of claim 7, wherein the push rod mechanism of the displacement feedback unit is disposed at a position corresponding to the inner sides of the middle finger, the ring finger, and the little finger of the human body, and the second actuator operates to rotate the turning linkage and then to push and displace the push rod mechanism downward against the inner sides of the middle finger, the ring finger, and the little finger of the human body for generating the co-directional force.

9. The handheld force feedback system of claim 7, wherein the push rod mechanism of the displacement feedback unit is further connected with a spring element; when the second actuator operates to rotate the turning linkage, the push rod mechanism is pushed and displaced downward from an original position, and the spring element is stretched; when the second actuator operates again to return the turning linkage, the spring element is rebounded, and the push rod mechanism is displaced upward so that the push rod mechanism returns to the original position.

10. The handheld force feedback system of claim 7, wherein the third actuator of the vibration feedback unit is adjusted by regulating the third input voltage for generating different vibration amplitudes.

11. The handheld force feedback system of claim 7, wherein the direction feedback unit, the displacement feedback unit, and the vibration feedback unit are integrated in a handle bar body.

12. The handheld force feedback system of claim 7, further comprising:
a tracking device, electrically connected to the handheld force feedback device, the tracking device sending out spatial motion information that tracks the handheld force feedback device when the handheld force feedback device moves; and
an electronic apparatus, electrically connected to a display and the tracking device and having a built-in virtual reality application program, the electronic apparatus receiving the spatial motion information, the virtual reality application program used to generates interactive information on the basis of the spatial motion information, the electronic apparatus sending the interactive information to the control unit, the control unit converting the interactive information into the collision force, converting the collision force into the output displacement, and then converting the output displacement into the rotation angle of the second actuator, and the control unit further generating the third input voltage for driving the third actuator and the first input voltage for driving the first actuator on the basis of the output displacement.

13. The handheld force feedback system of claim 12, wherein the tracking device transmits the spatial motion information to the electronic apparatus, the electronic apparatus displays a virtual collision action of a virtual object synchronously in a virtual environment through the display, and after the electronic apparatus detects the virtual collision action, it transmits the interaction information to the control unit.
